(19) United States
(12) Patent Application Publication
(10) Pub. No.: US 2006/0068175 A1
(43) Pub. Date: Mar. 30, 2006

(54) Fiber-reinforced decorative laminate

(75) Inventors: Fouad Torkum Karam, Hamden, CT (US); Sylvie Gauthier, Shelton, CT (US)

Correspondence Address: O'SHEA, GETZ & KOSAKOWSKI, P.C., 1500 MAIN ST., SUITE 912, SPRINGFIELD, MA, 01115, US

(73) Assignee: Panolam Industries International, Inc., Shelton, CT (US)

(21) Appl. No.: 11/254,223

(22) Filed: Oct. 18, 2005

Related U.S. Application Data
(63) Continuation-in-part of application No. 10/857,202, filed on May 28, 2004.

(51) Int. Cl. B44C 1/17

(52) U.S. Cl. 428/195.1

(57) ABSTRACT

A fiber-reinforced decorative laminate, and a method for producing the same, is provided. The method includes the steps of: 1) stacking in a superimposed relationship a decorative layer, a fiber-reinforced core layer, and a barrier layer disposed between the decorative layer and the core layer; and 2) simultaneously curing, under heat and pressure, the decorative, barrier and core layers to create the fiber-reinforced decorative laminate. The decorative layer includes one or more decorative sheets, and is at least partially resin-impregnated and at least partially cured. The fiber-reinforced core layer has a texture, and includes at least one fiber-reinforced sheet that is substantially devoid of cellulose. The core layer is at least partially resin-impregnated and at least partially cured. The barrier layer is operable to substantially prevent the texture of the core layer from being apparent through the decorative layer in the cured fiber-reinforced laminate.

This application is a continuation-in-part of U.S. patent application Ser. No. 10/857,202, filed on May 28, 2004.

### BACKGROUND OF THE INVENTION

1. Field of the Invention

The present invention relates to decorative laminates in general and, more particularly, to decorative laminates having a fiber-reinforced layer. In addition, the present invention relates to a method for manufacturing the same.

2. Background Information

High pressure decorative laminates are often used in the construction of kitchen and bath cabinetry, furniture, store fixtures and other building products. Heat and pressure consolidated decorative laminates are generally produced utilizing a core material comprising a plurality of phenolic resin impregnated kraft paper sheets, a face sheet impregnated with a melamine-formaldehyde resin and optionally a melamine resin impregnated overlay sheet. These high pressure laminates, examples of which are described in U.S. Pat. No. 3,418,189 to Grosheim et al., U.S. Pat. No. 4,311,748 to Casey et al., and U.S. Pat. No. 4,473,613 to Jaisle et al., have found world-wide acceptance as construction materials, i.e., wall panels, countertops, etc. in the home and office. They can be prepared so as to function in a variety of service applications and can be produced with surfaces such as high gloss, a matte finish or an embossed finish. There is considerable consumer demand for decorative laminates in a variety of colors, patterns, and textures. Furthermore, high pressure decorative laminates capable of withstanding high abuse in applications such as high-traffic corridor areas of stores, restaurants, hotels, schools and hospitals are also highly desirable.

Decorative laminates are usually laminated or glued in a separate operation to a structural base or substrate. Typically, the structural base has been formed from plywood, particleboard, chipboard, hardboard, wood waste, medium- or high-density fiberboard. Although not as common, it is also known to form the structural base from recycled plastic, ABS/PC, nylon, and/or PVC.

U.S. Pat. No. 4,871,596 to Kamiya et al. discloses an artificial marble laminate formed from a plurality of porous cellulosic sheets impregnated with a melamine resin. Each of these resin-impregnated cellulosic sheets, although mostly composed by weight of either alpha-cellulose or linter fiber, may include a limited amount of non-cellulose fiber, such as glass, carbon, polyester, or nylon fiber. Kamiya discloses a two-step process for forming the finished laminated panel. In the first step, the resin-impregnated cellulosic sheets may be cured with a decorative layer to form a decorative laminate. In the second step, the decorative laminate is bonded to the structural base material such as plywood.

Composite structural panels formed from woven, non-woven or chopped fibers bound together with a thermosetting or a thermoplastic resin have been available for some time. Typical high-modulus or high-strength fibers include, among others, glass, graphite, Kevlar® or aramid, boron, polyethylene, polyimide, or silicon carbide.

Generally, composite fiber-reinforced panels are formed from multiple layers or plies of the resin-impregnated fiber-reinforced sheets. The individual layers of a multi-layer composite fiber-reinforced panel need not be identical, but can vary in the style, fiber material, thickness, and orientation of the fiber-reinforcing sheets and in the specific resin material used, additives to the resin, and amount of impregnation.

Presently available composite fiber-reinforced panels lack desirable decorative qualities such as color or patterns.

### SUMMARY OF THE INVENTION

According to the present invention, a method for the production of a fiber-reinforced decorative laminate is provided. The method includes the steps of: 1) stacking in a superimposed relationship a decorative layer, a fiber-reinforced core layer, and a barrier layer disposed between the decorative layer and the core layer; and 2) simultaneously curing, under heat and pressure, the decorative, barrier and core layers to create the fiber-reinforced decorative laminate. The decorative layer includes one or more decorative sheets, and is at least partially resin-impregnated and at least partially cured. The fiber-reinforced core layer has a texture, and includes at least one fiber-reinforced sheet that is substantially devoid of cellulose. The core layer is at least partially resin-impregnated and at least partially cured. The barrier layer is operable to substantially prevent the texture of the core layer from being apparent through the decorative layer in the cured fiber-reinforced laminate.

Also according to the present invention, a heat and pressure consolidated laminate is provided that comprises in superimposed relationship a decorative layer consisting of one or more cellulosic pigmented sheets impregnated with a transparent thermosetting resin, a core layer containing at least one fiber-reinforced sheet that is substantially devoid of cellulose, and a barrier layer disposed between the decorative layer and the core layer. The decorative layer, barrier layer and core layer are consolidated by heat and pressure to provide a fiber-reinforced decorative laminate (“fiber-reinforced decorative laminate”) having desirable flexural strength, impact resistance as well as having desirable resistance to water absorption, fire, chipping, and being easily fabricated.

An advantage of the present invention is that it provides a laminate having desirable impact-resistant characteristics relative to prior art laminates. A further advantage of the present invention is that it provides a lightweight decorative laminate with desirable flexural strength for use in situations where the laminate may be subject to impact loads. Another advantage of the present invention is that the presence of a decorative layer does not adversely affect the flammability of the fiber-reinforced laminate. In addition, the fire-resistant properties of embodiments of the present fiber-reinforced decorative laminate are superior to those of many conventional high pressure decorative laminates. In fact, embodiments of the present laminate meet the standards of a Class A type fire-resistant laminate. Another advantage of the present invention is that the complete fiber-reinforced decorative laminate may be formed in a single curing operation.

These and other features and advantages of the present invention will become apparent in light of the drawings and detailed description of the present invention provided below.

### DESCRIPTION OF THE DRAWINGS

FIG. 1 is a cross sectional view (not to scale) of the superimposed constituent layers according to the first embodiment of the present invention; and

FIG. 2 is a cross sectional view (not to scale) of the superimposed constituent layers according to another embodiment of the present invention.

FIG. 3 is a cross sectional view (not to scale) of the superimposed constituent layers according to another embodiment of the present invention.

FIG. 4 is a cross sectional view (not to scale) of the superimposed constituent layers according to another embodiment of the present invention.

### DETAILED DESCRIPTION OF THE INVENTION

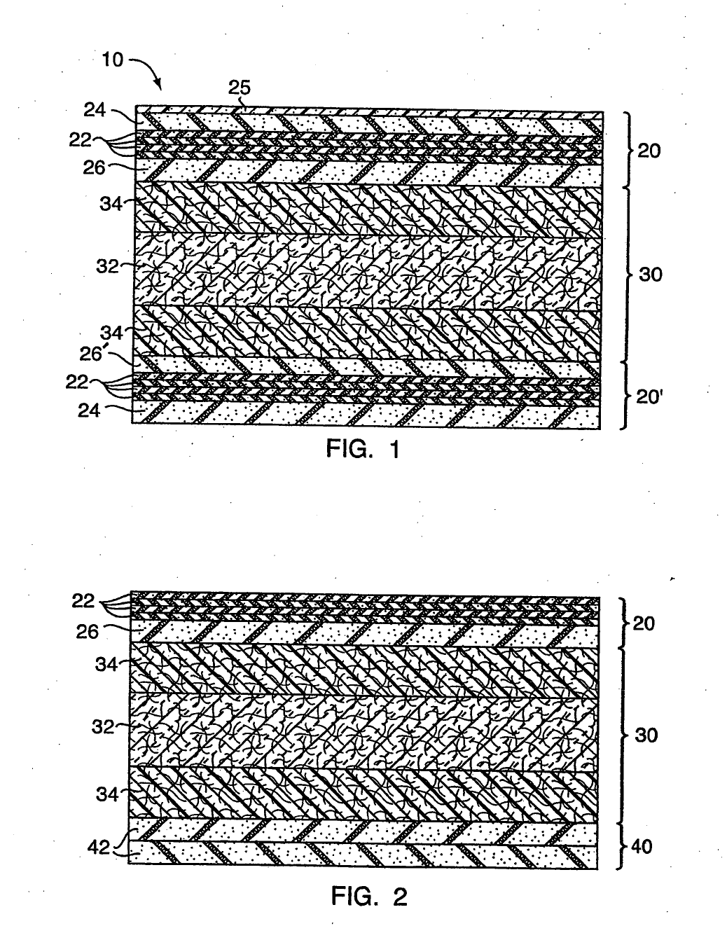

Now referring to FIGS. 1-4, the decorative laminated structure 10 of the present invention is generally represented by reference numeral 10. The decorative laminated structure 10 includes a decorative layer 20, a barrier layer 26, a fiber-reinforced core layer 30 and an optional backer layer 40 or second decorative layer 20′.

The decorative layer 20 includes one or more sheets 22. In its simplest configuration, the decorative layer 20 includes one or more decorative sheets 22. The decorative layer 20 may further include an overlay layer 24. The decorative layer 20 may be impregnated, fully or partially, with a thermosetting resin. The decorative layer 20 or the core layer 30 may also be described as including the barrier layer 26. The barrier layer 26 is more fully described below.

As used herein, the term “sheet” generally means a thin, distinct ply. A sheet may be planar, but a sheet may also be capable of assuming a non-planar configuration, for example, sheets that conform to three-dimensional structures. A decorative sheet 22 may be a cellulosic sheet. A cellulosic sheet includes any thin layer formed substantially of plant fibers or processed plant fibers, for example, paper, alpha-cellulose, or linter products. Alternatively, a decorative sheet may be formed from fabrics, polymeric sheets, such as a polyester non-woven, and any other continuous, discontinuous or particulate material, or combination of materials, capable of imparting a color or design to the finished laminate. Decorative sheets 22 may be pigmented throughout, may have a design woven into their structure, or may have a design printed on their surface. Optionally, a top coating 25 may be applied to the decorative layer 20 or it may be applied to the overlay layer 24. The top coat 25 may include abrasive particles. The decorative layer 20 may be impregnated, fully or partially, with a resin. Typically, the resin is a thermosetting resin.

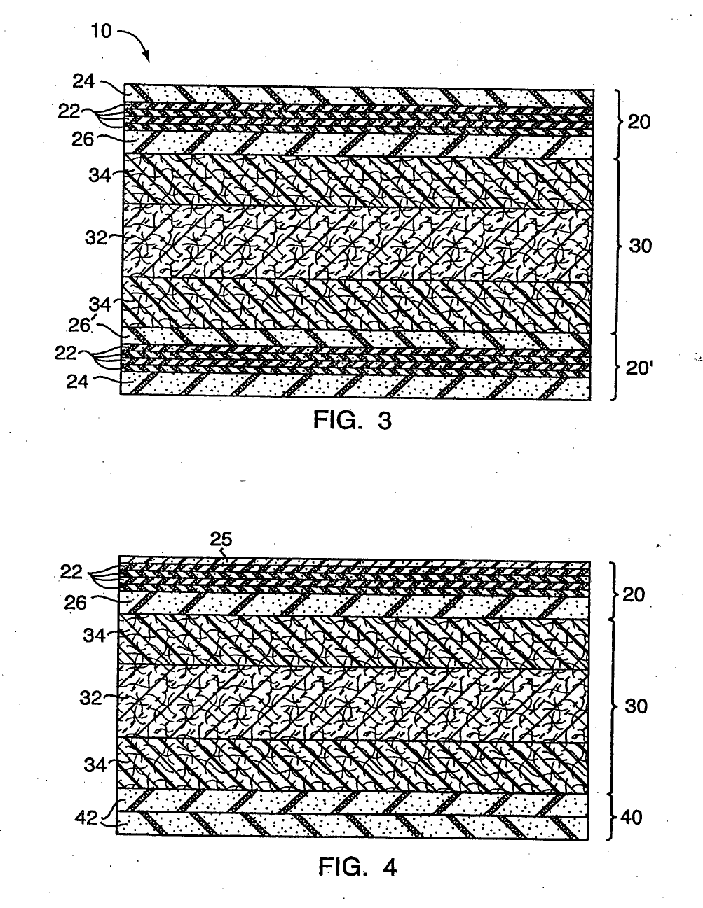

Referring to FIGS. 1 and 3, the overlay layer 24 may include one or more cellulosic sheets; e.g., alpha-cellulosic sheets. The overlay layer 24 may further include abrasive particles, as known in the art, to impart increased abrasion resistance to the layer 24. The overlay layer 24 may be impregnated, fully or partially, with a resin. For example, the overlay layer 24 may be formed of high-quality alpha-cellulose paper impregnated with a thermosetting resin. Typically, the alpha-cellulose paper acts as a translucent carrier for the resin, imparts strength to the resin, facilitates maintaining a uniform resin thickness, and provides a measure of abrasion resistance to the decorative layer 20.

Referring to FIGS. 1-4, the barrier layer 26 is disposed between the decorative layer 20 and the core layer 30. In those embodiments having a second decorative layer 20′ (FIGS. 1 and 3), the decorative laminated structure 10 may further include a second barrier layer 26′ disposed between the core layer 30 and the second decorative layer 20′. Each barrier layer 26, 26′ includes one or more cellulosic sheets, which may or may not be fully or partially impregnated with a thermosetting or other suitable resin; e.g., a melamine-formaldehyde resin, a phenol-formaldehyde resin or other thermosetting or thermoplastic resin. The barrier layer 26,26′ is most preferably impregnated, fully or partially, with a phenolic resin. The phenolic resin promotes desirable flexibility characteristics within the barrier layer 26, 26′. The barrier layer 26, 26′ prevents the texture of the fiber-reinforced core layer 30 from “telegraphing” through the decorative layer 20; i.e., the relatively rough texture of the fiber-reinforced core layer 30 is obscured by the barrier layer 26, 26′ and therefore not practically apparent through the decorative layer 20. The embodiments of the present invention decorative laminated structure 10 that include a barrier layer 26, 26′ and in particular a barrier layer 26, 26′ partially/wholly impregnated with a phenolic resin, also possess an improved ability to resist impact relative to many prior art laminates.

In some embodiments, the barrier layer 26,26′ is impregnated, wholly or partially, with a resin containing a fire-resistant agent. Examples of acceptable fire-resistant agents include: aluminum hydroxide, aluminum tri-hydrate, magnesium hydroxide, or diammonium phosphate (DAP), or some combination thereof. The inclusion of the one or more of the aforementioned agents within the resin gives the decorative laminated structure 10 desirable fire-resistant properties. In fact, embodiments of the present decorative laminated structure 10 impregnated with a sufficient amount of such resin meet the National Fire Protection Standards for Class A materials. Fire-resistant embodiments of the present decorative laminated structure 10, consequently provide an attractive, substantially less expensive alternative to fire-resistant laminates that predominately use other materials such as fiberglass, etc. At the same time, this embodiment of the present invention decorative laminated structure 10 provides desirable strength and flexibility; i.e., a laminate that is comparatively less brittle.

The fiber-reinforced core layer 30 includes at least one fiber-reinforced sheet, which is substantially devoid of cellulose. The use of the phrase “devoid of cellulose” means that the sheet contains no plant fiber or processed plant fiber product. The use of the phrase “substantially devoid of cellulose” means that the sheet may have some minor amount of plant fiber product, but the majority of the sheet, by weight, is composed of non-plant fiber materials. For example, the core layer 30 may include multiple sheets or plies that are reinforced only with glass, carbon, aramid, boron, and other known synthetic reinforcing fibers. The fiber-reinforced sheets may be supplied as woven or non-woven sheets, and as continuous or discontinuous fibers, as are generally known in the art. For example, as shown in FIG. 1, a chopped glass fiber sheet 32 may be sandwiched between two woven aramid (Kevlar®) fiber sheets 34.

The fiber-reinforced core layer 30 may also include nonfiber-reinforced sheets, for example, a sheet of solid or foamed polymeric material or a sheet of resin filled with particulate matter. These nonfiber-reinforced sheets may be interspersed within the fiber-reinforced core layer 30. Alternatively, it is within the scope of the present invention, for fiber-reinforced core layer 30 to contain cellulose sheets in addition to at least one fiber-reinforced sheet that is substantially devoid of cellulose. As an example, the core layer 30 may be considered to include a barrier layer 26, 26′ that includes cellulose sheets. As a further example, the core layer 30 may include one or more fiber-reinforced cellulosic sheets in addition to the at least one fiber-reinforced sheet, which is substantially devoid of cellulose.

The fiber-reinforced core layer 30 may be impregnated with a thermosetting or a thermoplastic resin, as is also known in the art. Impregnation may be full or partial, and the resin may be partially cured. The constituents of the core layer 30 may in some embodiments be impregnated, wholly or partially, with different resins. For example, the at least one fiber-reinforced sheet 32, 34 may be partially/wholly impregnated with a melamine resin and the cellulose sheets of the barrier layer 26, 26′ may be partially/wholly impregnated with a phenolic resin.

As stated above, some embodiments of the decorative laminated structure 10 include a backer layer 40. The backer layer 40, as shown in FIGS. 2 and 4, is disposed on the side of the fiber-reinforced core layer 30 opposite the decorative layer 20. The backer layer 40 may be formed of one or more sheets 42, which may or may not be coated or impregnated with a resin. The backer layer 40 typically includes a cellulosic material such as kraft paper. In one embodiment of the present invention laminated structure 10, the backer layer 40 may be coated or impregnated with a thermosetting resin and partially cured. In some embodiments, the backer layer 40 substantially consists of a fire-retardant material; e.g., a fire-retardant kraft paper. During curing of the decorative laminated structure 10, the backer layer 40 is thermofused to the fiber-reinforced core layer 30.

Also optionally, rather than including a backer layer 40, the decorative laminated structure 10 may include a second decorative layer 20′, as shown in FIGS. 1 and 3. This second decorative layer 20′ would be disposed on the side of the fiber-reinforced core layer 30 opposite the first decorative layer 20. The second decorative layer 20′ may be the mirror image (possibly with the exception of the specific design incorporated into decorative sheet) of the first decorative layer 20. Alternatively, the second decorative layer 20′ may not contain the identical sheets as in the build up of the first decorative layer 20.

In the partially cured state, the sheets of the decorative layer 20, the sheets of the barrier layer 26, the sheets of the fiber-reinforced core layer 30, the sheets of the second barrier layer 26′ and the sheets of the backer/decorative layer 20′ may be drapable. The term drapable, as used herein to describe the various sheets of the present invention, is intended to mean that the materials are substantially flaccid, and have the ability to conform to two- or three-dimensional features in a substantially uniform fashion. In the cured state, the decorative laminated structure 10 may be quasi-flexible or essentially rigid. The term quasi-flexible, as used herein, means that the stiffness characteristics of the structure come into play and that only a limited amount of flexing without incurring permanent damage is possible. With an essentially rigid decorative laminated structure, the stiffness characteristics of the structure as a whole dominate, although individual plies or groups or plies may remain flexible or quasi-flexible. In addition, the flexibility of the structure can be modified to suit a particular application by altering or changing the resins and/or the thickness of the structure.

Many of the present decorative laminated structure 10 embodiments have desirable impact-resistant characteristics. As used herein, the term “impact-resistant” means the ability to withstand relatively low-energy and/or low-speed blunt objects impinging or striking the surface of the structure 10 with no, or only minor, damage. In general, an impact-resistant structure may resist the formation of cracks radiating from the point of impact and the delamination of plies beneath the point of impact.

Prior to curing, the sheets of the decorative layer 20, the barrier layer 26, the fiber-reinforced core layer 30, the second barrier layer 26′ and the backer 40 or second decorative layer 20′ may be processed to improve their handleability. This may include, for example, partially drying a sheet to remove some of the more volatile elements from the resin, thereby reducing the stickiness of the sheet.

Thermosetting resins, thermoplastic resins, and their various additives are well known in the art and are commercially available. The properties of specific resins will not be described in further detail other than to say that specific parameters of the resin may be chosen to best accommodate the application at hand. For instance, certain resins and additives might be selected based on their ability to provide desirable impact-resistance and bonding strength depending upon the fiber-reinforcements, fire-resistance, overall panel flexibility, resistance to degradation due to heat, moisture, or radiation cycles, etc.

A first process of manufacturing the present fiber-reinforced decorative laminated structure 10 involves stacking a decorative layer 20, a barrier layer 26, a fiber-reinforced core layer 30, a second barrier layer 26′, and a backer layer 40 (or optionally a second decorative layer 20′ in place of the backer layer 40) in a superimposed relationship (i.e., a “build-up”) between caul plates. The build-up is then subjected to a predetermined pressure and temperature for a time sufficient to consolidate the respective layers. Once the build-up has consolidated at the aforesaid pressure and temperature, the build-up is subsequently cooled to a predetermined temperature while remaining at an elevated pressure. Cooling the consolidated build-up under pressure greatly decreases the propensity of the laminated structure 10 to warp.

A second process for manufacturing the present fiber-reinforced decorative laminated structure 10 involves continuously, or semi-continuously, supplying to a continuous press a decorative layer 20, a barrier layer 26, a fiber-reinforced core layer 30, a second barrier layer 26′, and a backer layer 40 (or optionally a second decorative layer 20′ in place of the backer layer 40), in the aforesaid superimposed relationship, from sources upstream of the continuous press. The continuous press is set up to create the temperature and pressure environment required to thermally consolidate the layers into the finished laminated product. The line speed of the continuous press is chosen to create a dwell time within the press that is adequate to ensure sufficient consolidation of the various layers. A release sheet may be disposed on each side of the build-up prior to entering the press. The release sheets are typically drawn off after the laminated structure exits the press. The continuous press may be advantageous because it decreases the processing time of the laminated structure, although use of the continuous press requires that the sheets fed into the press be continuous (or semi-continuous) and have a certain measure of handleability. Once the layers have consolidated within the continuous press, the laminated structure 10 is subsequently cooled to a predetermined temperature while remaining at an elevated pressure. Cooling the laminated structure 10 under pressure greatly decreases the propensity of the laminated structure 10 to warp.

In both of the above-described manufacturing processes, the elevated temperature and pressure causes the resins within the sheets to flow within and between the layers, allowing the layers to consolidate and form the integral laminated structure. In the discontinuous curing process, the present invention would generally be processed at a temperature in the range from about 110° C. to about 170° C., at a pressure within the range of about 500 psi to about 1600 psi, and subsequently cooled under a pressure within the aforesaid range to a temperature of between about 40° C. to about 80° C. In the continuous curing process, the present invention would generally be processed at a temperature above about 120° C. (with the temperature range depending on the dwelling time of the laminated structure in the press), at a pressure within the range of about 300 psi to about 1000 psi, and subsequently cooled under pressure within the aforesaid range by passage between and/or around cooling rolls to a temperature of between about 40° C. to about 80° C. Curing temperatures and pressures are typically selected based on the specific resin in use and the ultimate desired properties of the cured laminated structure. Curing temperatures can also be manipulated to suit the speed of the process; e.g., higher curing temperatures can be used at higher processing speeds and lower curing temperatures can be used at lower processing speeds.

In some embodiments, the cured decorative laminated structure 10 described above is designed to be subsequently attached to another structure. For example, the decorative laminated structure 10 can be adhesively or mechanically fastened to cargo-carrying products or to walls in high-traffic corridors to provide protection from impact or other damage. As another example, the decorative laminated structure 10 can be permanently or removably attached to a finished piece of furniture in an after-market situation.

The following examples are illustrative of the inventive decorative laminated structure 10 and do not constitute any limitation with regard to the subject matter of the invention:

### EXAMPLE I

A decorative laminated structure 10 is manufactured using a non-continuous press. A build-up consisting of a release sheet, a decorative layer 20, a barrier layer 26, a fiber-reinforced core layer 30, a second barrier layer 26′ and a backer layer 40 is made in a superimposed relationship and placed between steel caul plates. The decorative layer 20 includes a solid color decor paper treated with melamine resin. The first and second barrier layers 26, 26′ each include one or more sheets of kraft paper, each of which are at least partially impregnated with a phenolic resin. The fiber-reinforced core layer 30 includes one or more plies of glass cloth impregnated with melamine resin. Each glass cloth ply is formed of woven glass fabric, style 7628, with finish 516. The backer layer 40 is regular 65-lbs. HP balancing paper. The build-up is then subjected to a pressure of about 1100 psi. Once the predetermined pressure is reached, the press is heated to a predetermined temperature of about 140° C. The press is held at the predetermined pressure and temperature for a heating cycle of about 10 minutes. The pressed laminate is then cooled in the press under pressure of about 1100 psi to a temperature of about or under 60° C. The pressure is then released and the fiber-reinforced decorative laminated structure 10 is removed from the press. The resulting laminate is approximately 0.050 inches thick. Cooling the decorative laminated structure 10 in the press under pressure desirably increases the flatness of the final decorative laminated structure 10.

Alternatively, the decorative layer 20 may include a printed decor paper treated with melamine resin and an overlay layer 24, also treated with melamine resin. Also alternatively, the fiber-reinforced core layer 30 could be formed of multiple plies of glass cloth, in which case the resulting laminate would be approximately 0.090 inches thick. Optionally, more or fewer glass cloth plies or different types of glass cloth plies could be used to provide almost any thickness of pressed laminate. In even other alternatives, the backer layer 40 may be selected from fire retardant kraft paper or kraft 118 lb. paper treated with a fast cure phenolic resin.

### EXAMPLE II

The fiber-reinforced decorative laminated structure 10 is manufactured using a GreCon continuous high pressure laminating press, which includes an inlet section, a heating section and a cooling section. The cooling section includes a plurality of rolls. The temperature of each section is controlled independently. The total amount of heat imparted to the layers of the build-up is controlled by the temperature of the different sections and the dwell time, which is dependent on the line speed. This continuous process requires that the various sheets used to manufacture the laminate be fed into the press as continuous webs. A roll of decor paper treated with melamine resin provides the decorative layer 20, rolls of kraft paper provide the barrier layers 26, 26′, multiple rolls of the glass cloth provide the fiber-reinforced core layer 30, and a roll of kraft paper provides the backer layer 40, all of which are situated upstream of the continuous press in a manner enabling them to continuously enter the press in the aforesaid superimposed relationship. The temperature settings of the different press sections are as follows: the inlet section is set at approximately 200° C., the heating section is set at approximately 185° C., and the cooling section is set at approximately 15° C. The pressure in all sections may be set at about 350 psi. The line speed of the continuous press is set at about 5 ft/min to create a dwell time within the press of approximately 2.4 minutes.

It will be obvious to those skilled in the art that various changes may be made without departing from the scope of the present invention and that the invention is not to be considered limited to what is described and exemplified in the specification.

What is claimed is:

1. A method for the production of a fiber-reinforced decorative laminate comprising:
stacking in a superimposed relationship a first decorative layer, which includes one or more decorative sheets, the first decorative layer being at least partially resin-impregnated and at least partially cured, a fiber-reinforced core layer having a texture, which core layer includes at least one fiber-reinforced sheet that is substantially devoid of cellulose, and which core layer is at least partially resin-impregnated and at least partially cured, and a first barrier layer disposed between the first decorative layer and the core layer; and
simultaneously curing, under heat and pressure, the first decorative, first barrier and core layers to create the fiber-reinforced decorative laminate; and
wherein the first barrier layer is operable to substantially prevent the texture of the core layer from being apparent through the first decorative layer in the cured fiber-reinforced laminate.

2. The method of claim 1, wherein the first barrier layer includes one or more cellulosic sheets.

3. The method of claim 2, wherein the step of stacking further includes provides a second decorative layer and a second barrier layer, such that the core layer is disposed between the barrier layers, and the second decorative layer is contiguous with the second barrier layer, and wherein the second barrier layer is operable to substantially prevent the texture of the core layer from being apparent through the second decorative layer in the cured fiber-reinforced laminate.

4. A method for the production of a fiber-reinforced decorative laminate comprising:
stacking in a superimposed relationship a first decorative layer, which includes one or more decorative sheets, the first decorative layer being at least partially resin-impregnated and at least partially cured, a fiber-reinforced core layer having a texture, which core layer includes at least one fiber-reinforced sheet that is substantially devoid of cellulose, and which core layer is at least partially resin-impregnated and at least partially cured, and a first barrier layer disposed between the first decorative layer and the core layer, wherein the first barrier layer includes one or more cellulosic sheets that are at least partially impregnated with a resin that contains a fire-resistant agent; and
simultaneously curing, under heat and pressure, the first decorative, first barrier and core layers to create the fiber-reinforced decorative laminate.

5. The method of claim 4, wherein the fire-resistant agent is selected from the group consisting of aluminum hydroxide, aluminum tri-hydrate, magnesium hydroxide, and diammonium phosphate.

6. A fiber-reinforced decorative laminated panel, comprising:
a decorative layer impregnated, at least partially, with a thermosetting resin;
a core layer that includes at least one non-cellulosic, fiber-reinforced sheet impregnated, at least partially, with a thermosetting resin, wherein the at least one fiber-reinforced sheet is selected from one of a woven glass fiber sheet, a non-woven glass fiber sheet, and a chopped glass fiber sheet; and
a barrier layer disposed between the decorative layer and the core layer, wherein the barrier layer is operable to substantially prevent the texture of the core layer from being apparent through the decorative layer in the cured fiber-reinforced laminate.

7. The panel of claim 1, wherein the barrier layer includes one or more cellulosic sheets.

8. The panel of claim 7, further comprising:
a second decorative layer; and
a second barrier layer;
wherein the core layer is disposed between the barrier layers, and the second decorative layer is contiguous with the second barrier layer, and
wherein the second barrier layer is operable to substantially prevent the texture of the core layer from being apparent through the second decorative layer in the cured fiber-reinforced laminate.

9. A fiber-reinforced decorative laminated panel, comprising:
a decorative layer impregnated, at least partially, with a thermosetting resin;
a core layer that includes at least one non-cellulosic, fiber-reinforced sheet impregnated, at least partially, with a thermosetting resin, wherein the at least one fiber-reinforced sheet is selected from one of a woven glass fiber sheet, a non-woven glass fiber sheet, and a chopped glass fiber sheet; and
a barrier layer disposed between the decorative layer and the core layer, wherein the barrier layer includes one or more cellulosic sheets that are at least partially impregnated with a resin that contains a fire-resistant agent.

10. The panel of claim 9, wherein the fire-resistant agent is selected from the group consisting of aluminum hydroxide, aluminum tri-hydrate, magnesium hydroxide, and diammonium phosphate.

11. A method for the production of a fiber-reinforced decorative laminate comprising:
stacking in a superimposed relationship a decorative layer, which includes one or more decorative sheets, the decorative layer being at least partially resin-impregnated and at least partially cured, a fiber-reinforced core layer having a texture, which core layer includes at least one fiber-reinforced sheet that is substantially devoid of cellulose, and which core layer is at least partially resin-impregnated and at least partially cured, and a barrier layer disposed between the decorative layer and the core layer, wherein the barrier layer is operable to substantially prevent the texture of the core layer from being apparent through the first decorative layer in the cured fiber-reinforced laminate;
simultaneously curing, under heat and pressure, the stacked decorative, barrier and core layers; and
cooling the stacked decorative, barrier and core layers at an elevated pressure and temperature.

12. The method of claim 11, wherein the step of curing occurs in a non-continuous process.

13. The method of claim 12, wherein the step of cooling occurs at a pressure of between about 1000 psi to about 1200 psi, and a temperature of between about 50° C. to 70° C.

14. The method of claim 11, wherein the step of curing occurs in a substantially continuous process.

15. The method of claim 14, wherein the step of cooling occurs at a pressure of between about 200 psi to about 400 psi, and a temperature of between about 60° C. to 80° C.
